(19) United States
(12) Patent Application Publication
(10) Pub. No.: US 2007/0040365 A1
(43) Pub. Date: Feb. 22, 2007

(54) Vehicle data recorder

(75) Inventor: Ryuichi Asada, Tokyo (JP)

Correspondence Address: FOLEY AND LARDNER LLP;SUITE 500, 3000 K STREET NW, WASHINGTON, DC, 20007, US

(73) Assignee: CALSONIC KANSEI CORPORATION

(21) Appl. No.: 11/505,279

(22) Filed: Aug. 17, 2006

(30) Foreign Application Priority Data
Aug. 22, 2005 (JP) 2005-239859

(51) Int. Cl. B60R 21/01

(52) U.S. Cl. 280/735

(57) ABSTRACT

A vehicle data recorder includes plural vehicle state-detecting sensors for detecting a state of a vehicle at the time of running, a recording unit for temporarily recording detected values of the sensors, a recording/storing unit for recording and storing the detected values of the sensors; an airbag body, an airbag body controller configured to inflate the airbag body, a judging unit to judge that an event starts and to judge that the airbag body is to be developed and a control unit for performing (i) an recording operation that the detected values of said vehicle state detection sensors are recorded and taken into the recording unit at a predetermined cycle, (ii) a recording/storing operation that when the judging unit judges that the event starts, the detected values of the vehicle state-detecting sensors recorded in the recording unit are recorded and stored in said recording/storing unit, and (iii) an airbag controlling operation that when the judging unit judges that the airbag is to be developed, the control unit outputs said trigger signal to said airbag body control unit.

### CONVENTION PRIORITY TO BE CLAIMED

The convention priority of Japanese patent application No. 2005-239859 filed on Aug. 22, 2005 is claimed in this application, and the entire contents of this Japanese patent application are incorporated hereinto by referenced

### BACKGROUND OF THE INVENTION

(1) Field of the Invention

The present invention relates to a vehicle data recorder.

(2) Related Art Statement

Investigations have been recently made of vehicle data recorders (driving recorders) which are to be applied to vehicles as in a case of so-called flight recorders provided in aircrafts or the like. Such a vehicle data recorder constantly records data of a vehicle detected with a sensor installed in a vehicle, and is served to objectively analyze a cause resulting in an emergency state of the vehicle through post analysis of the data recorded, the emergency state being a case where the vehicle receives a predetermined intensity of an impact force from an exterior, for example (Such a case will be hereinafter referred to “a point of time of occurrence of an event” or “a point of time of event occurrence”). It is impractical for this vehicle data recorder to record the data for the entire running time period, because it requires a huge memory capacity. Consequently, data of the sensor for a given time period is overwritten on and stored in a rewritable recording medium. Such data as stored for a given time period before a point of time of the occurrence of the event, can be used in the post analysis (See JP 07-244064-A1).

A vehicle data recorder is known, in which a so-called airbag system is assembled to protect a passenger from an application of an impact upon a vehicle from an exterior thereof. Such a vehicle data recorder has a merit that an acceleration sensor, which is used in the airbag system, is commonly utilized in the vehicle data recorder (See JP 2003-252256-A1).

In many of such vehicle data recorders, in order to judge the occurrence of event, a point of time when an output from the sensor reaches or exceeds a threshold value is taken as a point of time of event occurrence. In many of vehicle data recorders which record output values from plural sensors, respective threshold values are set for these sensors so that each of the sensor may judge the occurrence of the event. However, in case that plural sensors are each adapted to judge the occurrence of the event, occurrence of an event resulting from a single event-provoking cause may be judged at plural times. For example, after it is judged that an event occurs in case that an output value from a given sensor reaches or exceeds its threshold value, it may be judged again that an event occurs in case that an output value of other sensor reaches or exceeds its threshold value. In this occasion, if a recording operation is such that data at a given time counted back from the point of time of the occurrence of the last event is recorded, the recorded data is a data recorded at the given time counted back from a point of time of the occurrence of a second event. However, if the occurrences of the events are judged for a single event-occurrence cause, for example, a case where an impact forces are continuously applied to the vehicle from the outside for a short time, data really required is a data at a given time counted back from the point of time when the first event occurs. Consequently, there occurs a problem that the necessary data is not recorded.

If a recording operation is always such that data at a given time counted back from a point of time of a first event is to be recorded, the recorded data is the data counted back from a point of time of the judgment of the first event. However, if a second event is an important event which requires a development of an airbag, there also remains a problem that a necessary data is not recorded in this case, since the data counted back from a starting point of time of the occurrence of the second event.

### SUMMARY OF THE INVENTION

It is another object of the present invention to provide a vehicle data recorder which can appropriately judge the start of an event based on detected values with a plurality of sensors and which can assuredly record and store detected values of the sensors in case that the event starts and in case that an airbag was developed.

In order to solve the above problem, the present invention relates to a vehicle data recorder comprising:

a plurality of vehicle state-detecting sensors for detecting a state of a vehicle at the time of running;

a recording unit for temporarily recording detected values of said plurality of the vehicle state detecting sensors;

a recording/storing unit for recording and storing the detected values of said plurality of the vehicle state detecting sensors;

an airbag body installed inside an interior of the vehicle and configured to mitigate an impact force applied from an exterior of the vehicle;

an airbag body controller configured to inflate the airbag body upon receipt of a trigger signal from outside thereof;

a judging unit configured to judge that an event starts when a detected value of a given one of said plurality of the vehicle state-detecting sensors reaches or exceeds a first threshold value and to judge that the airbag body is to be developed when said given one vehicle state-detecting sensor reaches or exceeds a second threshold value, the first threshold value being lower than the second threshold value; and

a control unit configured for performing (i) an recording operation that the detected values of said vehicle state detection sensors are recorded and taken into the recording unit at a predetermined cycle, (ii) a recording/storing operation that when the judging unit judges that said event starts, the detected values of the vehicle state-detecting sensors recorded in the recording unit are recorded and stored in said recording/storing unit, and (iii) an airbag controlling operation that when the judging unit judges that the airbag is to be developed, the control unit outputs said trigger signal to said airbag body control unit.

The following (1) to (7) are preferred embodiment of the present invention. Any combinations of (1) to (7) are also preferred embodiments of the present invention, unless any contradiction occurs.

(1) Said given one vehicle state-detection sensor comprises a plurality of vehicle state-detecting sensors, first and second threshold values are set for each of said plurality of the vehicle state-detecting sensors; it is judged that the event starts, when an event start condition that a detected value of any of said plurality of the vehicle state-detecting sensors reaches or exceeds the first threshold value is satisfied; and it is judged that the airbag is to be developed, when an airbag development condition that the detected value of any of said plurality of the vehicle state-detecting sensors reaches or exceeds the second threshold value is satisfied.

According to the above construction (1), when the event start condition is satisfied, the detected value of the vehicle state detecting sensor recorded in the recording unit is recorded in the recording/storing unit, and thus the state of the vehicle at the time of the event start can be effectively analyzed. Further, when the airbag development condition is satisfied, the airbag is developed and the detected value of the vehicle state detecting sensor recorded in the recording unit is recorded in the recording/storing unit, so that the state of the vehicle at the time of the airbag development can be effectively analyzed.

(2) Even if a new event start condition is satisfied within a predetermined time period after said event start condition was satisfied, it is not judged that the event starts.

According to the above construction (2), if the event start conditions are continuously satisfied, they are considered to be one event. Thereby, the detected value corresponding to a point of time of the first even start can be assuredly recorded.

(3) After it is judged that the airbag is to be developed, it is not judged that the event starts, even if the event start condition is satisfied.

According to the above construction (3), after it is judged that the airbag is to be developed, the detected value of the vehicle state detecting sensor recorded in the recording unit is not overwritten on the recording/storing unit. Thus, the detected value at the point of time of the airbag development can be assuredly recorded.

(4) Said vehicle state-detecting sensor comprises an acceleration sensor configured for detecting an impact force applied from an exterior of the vehicle and a running state-detecting sensor configured for detecting a running state of the vehicle, and said given vehicle state-detecting sensor is said acceleration sensor.

According to the above construction (4), the detected value of the acceleration sensor and the detected value of the running state detecting sensor are recorded. Thus, the state of the vehicle at the time of the occurrence of the event can be known in more detail, thereby enabling more precious post analysis.

(5) Said acceleration sensor comprises at least one a front acceleration sensor arranged near a front side of the vehicle for detecting an impact force from said front side, a central acceleration sensor arranged in a central portion of the vehicle for detecting an impact forces from the front side, a right side and a left side of the vehicle, a right-side acceleration sensor arranged near the right side of the vehicle for detecting an impact force from the right side of the vehicle, a left side acceleration sensor 214 arranged near the left side of the vehicle for detecting an impact forces from the left side of the vehicle, and an angular velocity sensor arranged near the central portion of the vehicle for detecting overturn of the vehicle.

According to the above construction (5), since the acceleration applied to the vehicle when the impact force is applied to the vehicle from the vehicle can be recorded as accelerations in plural directions, the post analysis can be made at a more high precision.

(6) Said running state-detecting sensor comprises at least one of a vehicle velocity sensor for detecting the velocity of the vehicle, an engine-rpm sensor for detecting the revolutions per minute of the engine installed in the vehicle, a brake on/off sensor for detecting the state of on/off of a brake, and an accelerator open degree sensor for detecting an open degree of an accelerator.

According to the above construction (6), the detected value of the running state-detecting sensor as well as the detected value of the acceleration sensor is recorded. Thus, the state of the vehicle at the time of the occurrence of the event can be known in more detail, and the post analysis can be made at a higher precision.

(7) Said recording unit comprises a so-called first-in, first-out type ring buffer.

According to the above construction (7), since the data over the entire running time needs not be recorded, the memory capacity can be reduced to realize the cost down.

### BRIEF DESCRIPTION OF THE DRAWINGS

For a better understanding of the invention, reference is made to the attached drawings, wherein:

FIG. 1 is a block diagram of an embodiment of the vehicle data recorder according to the present invention.

FIG. 2 is a figure for showing positions in the embodiment of the present invention where acceleration sensors are attached.

FIG. 3 is a flow chart showing a fundamental operation in the embodiment of the present invention.

FIG. 4 is a flow chart showing a first recording operation in the embodiment of the present invention.

FIG. 5 is a flow chart showing a second recording operation in the embodiment of the present invention.

FIG. 6 is a flow chart showing a judgment operation in an event-judging section in the embodiment of the present invention.

FIG. 7 is a flow chart showing a judgment operation in the event-judging section in the embodiment of the present invention.

FIG. 8 is a timing chart in the embodiment of the present invention.

FIG. 9 is another timing chart in the embodiment of the present invention.

### DETAILED DESCRIPTION OF THE INVENTION

The present invention will be explained based on embodiments with reference to the attached drawings, which are not restrictive to the present invention.

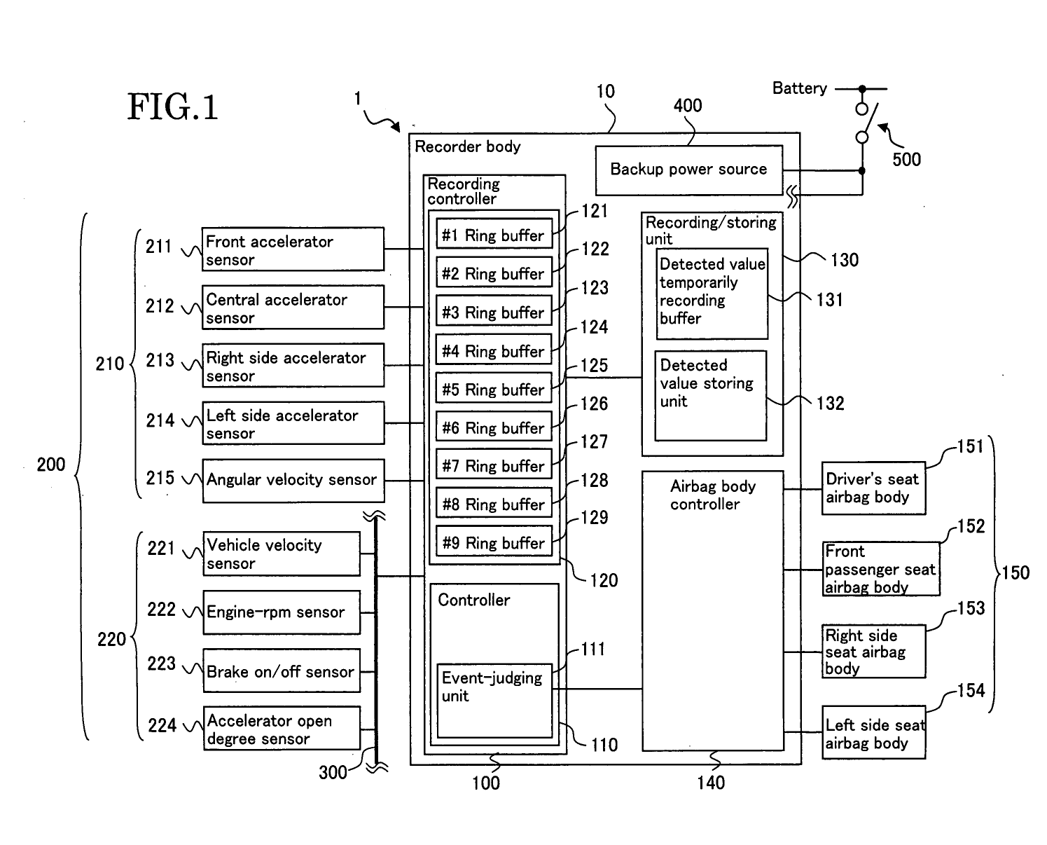

FIG. 1 shows a block diagram of an embodiment of the present invention. A vehicle data recorder body 10 of a vehicle data recorder 1 is electrically connected to a battery via an ignition switch 500. The recorder body 10 contains a power source 400 to be used when the recorder body is disconnected from the battery.

The recorder body 10 is electrically connected to an acceleration sensor unit 210 configured to detect impact forces applied to a vehicle from outside and to take in detected values from the sensor unit.

The acceleration sensor unit 210 comprises a front acceleration sensor 211 for detecting an impact force from a front side of the vehicle, a central acceleration sensor 212 for detecting an impact force from each of a front side, a right side and a left side of the vehicle, a right-side acceleration sensor 213 for detecting an impact force from the right side of the vehicle, a left side acceleration sensor 214 for detecting an impact force from the left side of the vehicle, and an angular velocity sensor 215 for detecting overturn of the vehicle.

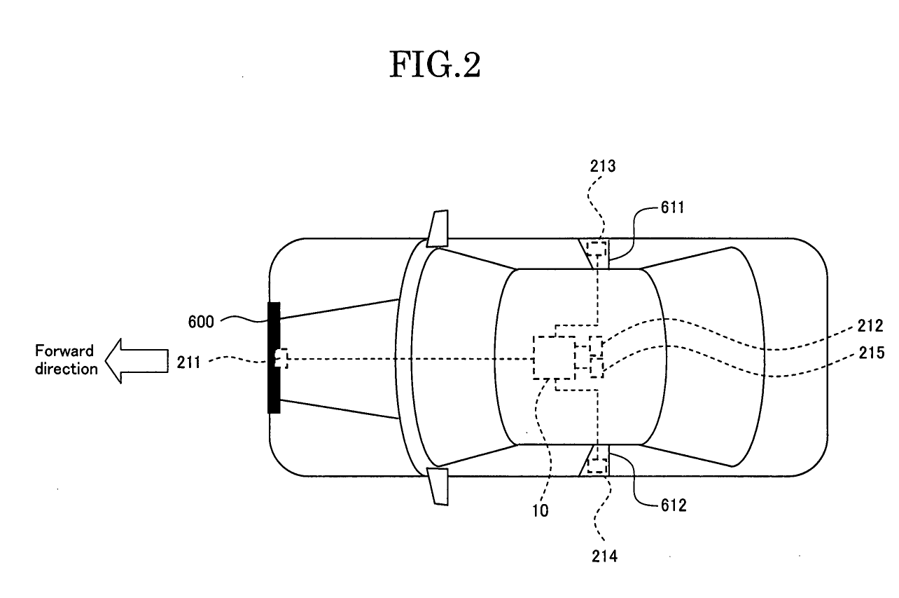

As shown in FIG. 2, the front acceleration sensor 211 is attached to near an inside of a front grill 600. The central acceleration sensor 212 and the angular velocity sensor 215 are attached to near inner side of a center console (not shown) or to an inside of the recorder body 10 in almost a central portion of the vehicle. The right side acceleration sensor 213 is attached to an inside of a right B-pillar 611 of the vehicle. The left side acceleration sensor 214 is attached to an inside of a left B-pillar 612 of the vehicle.

The recorder body 10 takes in detected values from a running state-detecting sensor unit 220 for detecting the running state of the vehicle, which detection outputs are outputted on a CAN (Controller Area Network) 300 (Standard of Decentralized Control Network).

The running state-detecting sensor unit 220 comprises a vehicle velocity sensor 221 for detecting the velocity of the vehicle, an engine-rpm sensor 222 for detecting the revolutions per minute of the engine (referred to as “ENG” in FIG. 1), a brake on/off sensor 223 for detecting the state of on/off of a brake, and an accelerator open degree sensor 224 for detecting the open degree of the accelerator.

The acceleration sensor unit 210 and the running state-detecting sensor unit 220 correspond to a vehicle state-detecting sensor 200 in the claimed invention.

The recorder body 10 comprises a recording controller 100 for controlling recording, a recording/storing unit 130 for recording and storing the detected values from the vehicle state-detecting sensor unit 200, and an airbag body controller 140 for controlling development of an airbag body unit 150.

The recording controller 100 comprises a control unit 110 as a CPU for controlling recordings, and a recording unit 120 for temporarily recording detected values detected by the acceleration sensor unit 210 and the running state-detecting sensor unit 220.

The control unit 110 is configured to record output values from the acceleration sensor unit 210 and the running state-detecting sensor unit 220 every a given sampling interval.

The recording unit 120 comprises a first ring buffer 121 (referred to as “#1” in FIG. 1) for recording detected values of the front acceleration sensor 211, a second ring buffer 122 (referred to as “#2” in FIG. 1) for recording detected values of the central acceleration sensor 212, a third ring buffer 123 (referred to as “#3” in FIG. 1) for recording detected values of the left side acceleration sensor 213, a fourth ring buffer 124 (referred to as “#4” in FIG. 1) for recording detected values of the left side acceleration sensor 214, a fifth ring buffer 125 (referred to as “#5” in FIG. 1) for recording the detected values from the angular velocity sensor 215, a sixth ring buffer 126 (referred to as “#6” in FIG. 1) for recording detected values of the vehicle velocity sensor 221, a seventh ring buffer 127 (referred to as “#7” in FIG. 1) for recording detected values of the engine-rpm sensor 222, and an eighth ring buffer 128 (referred to as “#8” in FIG. 1) for recording detected values of the brake on/off sensor 223, and a ninth ring buffer 129 (referred to as “#9” in FIG. 1) for recording detected values of the accelerator open degree sensor 224.

Each of the first ring buffer 121 to the ninth ring buffer 229 has a memory capacity capable of recording the detected values from the respective one of the sensors for a given time period TE1. Each ring buffer is a so-called first-in, first-out type ring buffer in which if it receives data exceeding its memory capacity available at that time, it takes in the new data after erasing the oldest one.

The control unit 110 comprises an event-judging unit 111 that compares output values V1 to V5 from the front acceleration sensor 211, the central acceleration sensor 212, the right side acceleration sensor 213, the left side acceleration sensor 214 and the angular velocity sensor 215, respectively with preset event-start threshold values VE1 to VE5 for the respective output values V1 to V5, respectively. The event-judging unit 111 judges that the event starts, if any of the event-starting conditions that V1≧VE1, V2≧VE2, V3≧VE3, V4≧VE4 and V5≧VE5 is satisfied. These event-start threshold values VE1 to VE5 correspond to the first threshold in the claimed invention.

A recording/storing unit 130 comprises a detected value temporarily recording buffer 131 and a detected value storing unit 132. The temporarily recording buffer 131 is a volatile memory which temporarily stores all the detected values recorded in a recording unit 120 outputted from the recording control unit 100 when the event-judging unit 111 judges that the event starts. The detected value storing unit 132 is a nonvolatile memory which records and stores the detected values recorded in the detected value temporarily recording buffer 131 when recording of the detected values into the detected value temporarily recording buffer 131 is terminated. Each of the detected value temporarily recording buffer 131 and the detected value storing unit 132 has a memory capacity sufficient to record the detected values of the first ring buffer 121 to the ninth ring buffer 129 for a binary manner of at least given periods of TE1 and TE2.

The airbag body controller 140 is electrically connected to the airbag body unit 150.

The airbag body unit 150 comprises an driver's seat airbag body 151, a front passenger seat airbag body 152 installed in an upper portion of a front passenger's seat instrument panel, a right side airbag body 153 installed inside a right side door of the vehicle and a left side airbag body 154 installed inside a left side door of the vehicle.

The event-judging unit 111 comprises airbag-developing threshold values VA1 to VA5 as standards in outputting the airbag development signals in addition to the above-mentioned event-start threshold values VE1 to VE5. The event-judging unit 111 judges that the airbag is to be developed if any of the airbag developing conditions that V1≧VA1, V2≧VA2, V3≧VA3, V4≧VA4 and V5≧VA5 with respect to the output values V1 to V5 of the front acceleration sensor 211, the central acceleration sensor 212, the right side acceleration sensor 213, the left side acceleration sensor 214 and the angular velocity sensor 215, and accordingly outputs an airbag-developing signal to the airbag body controller 140 is satisfied. The airbag developing threshold values VA1 to VA5 are second threshold values in the claimed invention.

When the airbag body controller 140 receives an airbag development signal outputted from the event judging unit 111, the controller 140 develops the driver's seat airbag body 151, the front passenger seat airbag body 152, the right side airbag body 153 and the left side airbag body 154.

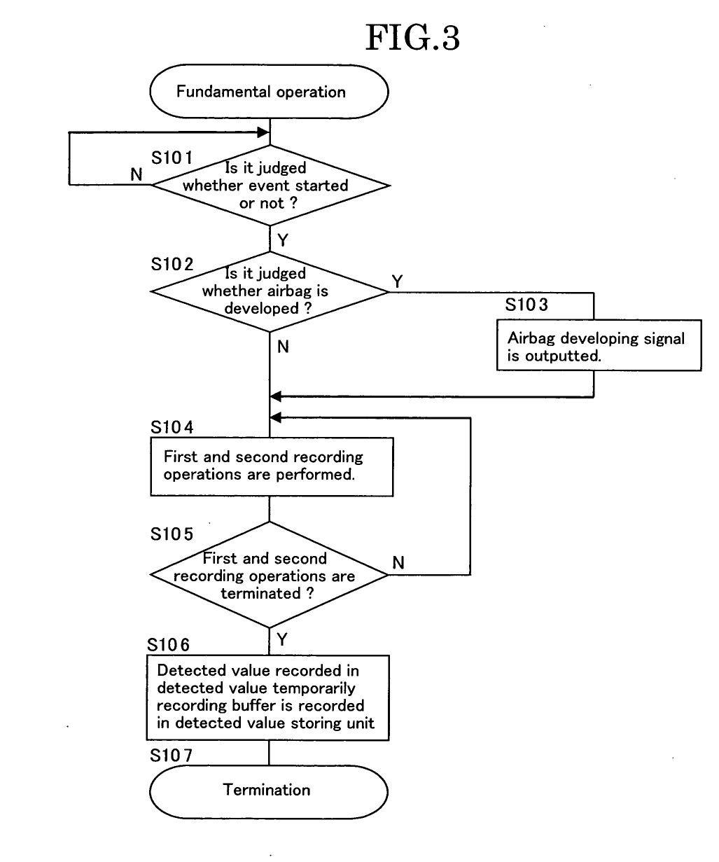

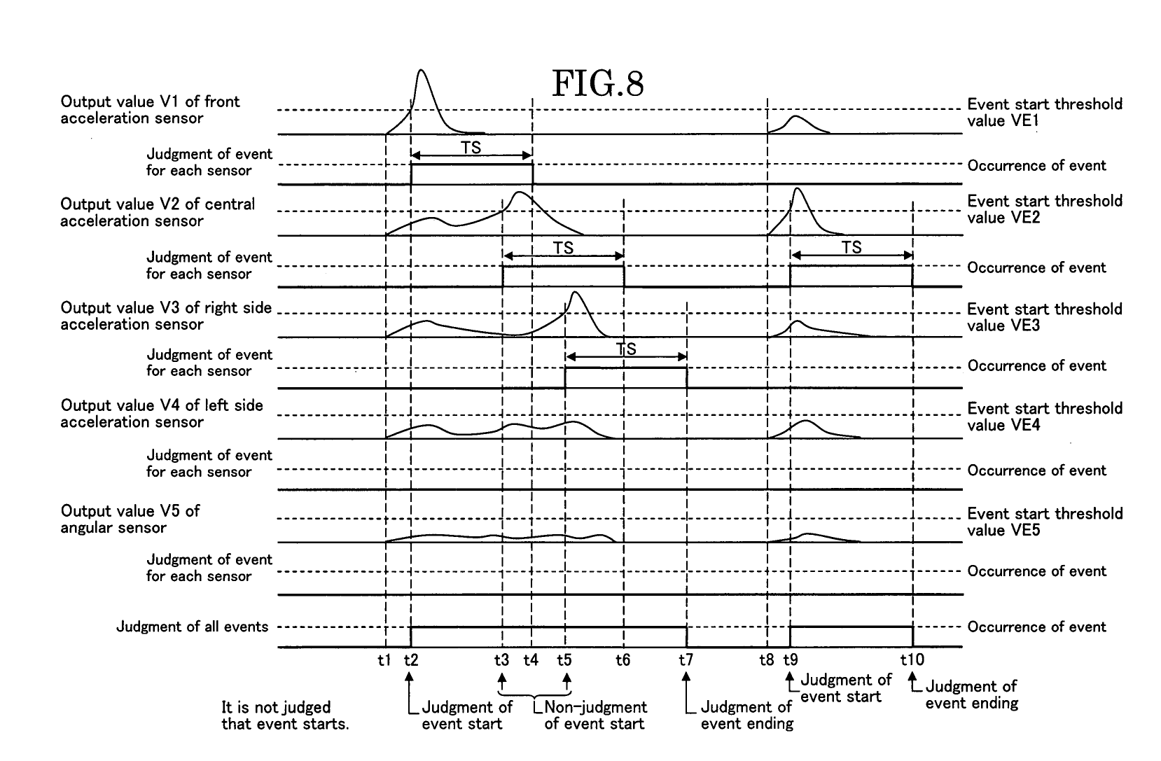

Next, operations of the recorder body 10 will be explained with reference to flow charts in FIGS. 3 to 7 and a timing chart in FIG. 8.

FIG. 3 is a flow chart illustrating the fundamental operation of the recorder body 10.

The recorder body 10 constantly loads the detected values of the front acceleration sensor 211, the central acceleration sensor 212, the right side acceleration sensor 213, the left side acceleration sensor 214, the angular velocity sensor 215, the vehicle velocity sensor 221, the engine-rpm sensor 222, the brake on/off sensor 223 and the accelerator open degree sensor 224 into the first ring buffer 121 to the ninth ring buffer 129 at a given cycle, respectively. This operation is a recording operation.

In Step S101, it is decided whether the event starting is judged by the event-judging unit 111 or not (mentioned latter). If it is judged that the event starts, the flow moves to Step S102. On the other hand, if it is not judged that the event starts (no judgment of event start), the flow returns to Step S101, and is in a waiting state.

In Step S102, it is decided whether the airbag development is judged or not by the event-judging unit 111 (mentioned later). If it is judged that the airbag development is to be performed, the flow moves to Step S103. On the other hand, if it is not judged that the airbag development is to be performed, the flow moves to Step S104.

In Step 103, the control unit 110 outputs an airbag development signal to the airbag body controller 140. The airbag body controller 140 which receives the airbag development signal develops the driver's seat airbag body 151, the front passenger seat airbag body 152, the right side airbag body 153 and the left side airbag body 154. Then, the flow moves to Step S104.

In Step S104, a first recording operation is performed: the detected values of the front acceleration sensor 211, the central acceleration sensor 212, the right side acceleration sensor 213, the left side acceleration sensor 214, the angular velocity sensor 215, the vehicle velocity sensor 221, the engine-rpm sensor 222, the brake on/off sensor 223 and the accelerator open degree sensor 224 already recorded in the first ring buffer 121 to the ninth ring buffer 129 of the recording unit 120, respectively, at the point of time when it is judged that the event starts are recorded into the detected value temporarily storing buffer 131 of the recording/storing unit 130. This first recording operation is a recording/storing operation in the claimed invention. At the same time, a second recording operation is performed: newly detected values of the acceleration sensor unit 210 and the running state detecting sensor unit 220 are recorded into the detected value temporarily storing buffer 131 of the recording/storing unit 130 from the point of time when it is judged that the event starts. The flow moves to Step S105.

In Step S105, it is judged whether the first and second recording operations are terminated or not. If it is judged that the first and second recording operations are terminated, the flow is returned to Step S104. On the other hand, if it is judged that the first and second recording operations are not terminated, the flow returns to Step S104 where the first and second recording operations are continued.

In Step S106, the detected values of the front acceleration sensor 211, the central acceleration sensor 212, the right side acceleration sensor 213, the left side acceleration sensor 214, the angular velocity sensor 215, the vehicle velocity sensor 221, the engine-rpm sensor 222, the brake on/off sensor 223 and the accelerator open degree sensor 224 recorded in the detected value temporarily storing buffer 131 are recorded in the detected value-storing unit 132. Since the detected value restoring unit 132 is the non-volatile memory, the recorded detected values are stored without being disappear, even if the electric power supply to the recording apparatus body 10 is stopped. Thereafter, the flow moves to Step S107.

The fundamental operation is terminated at Step S107.

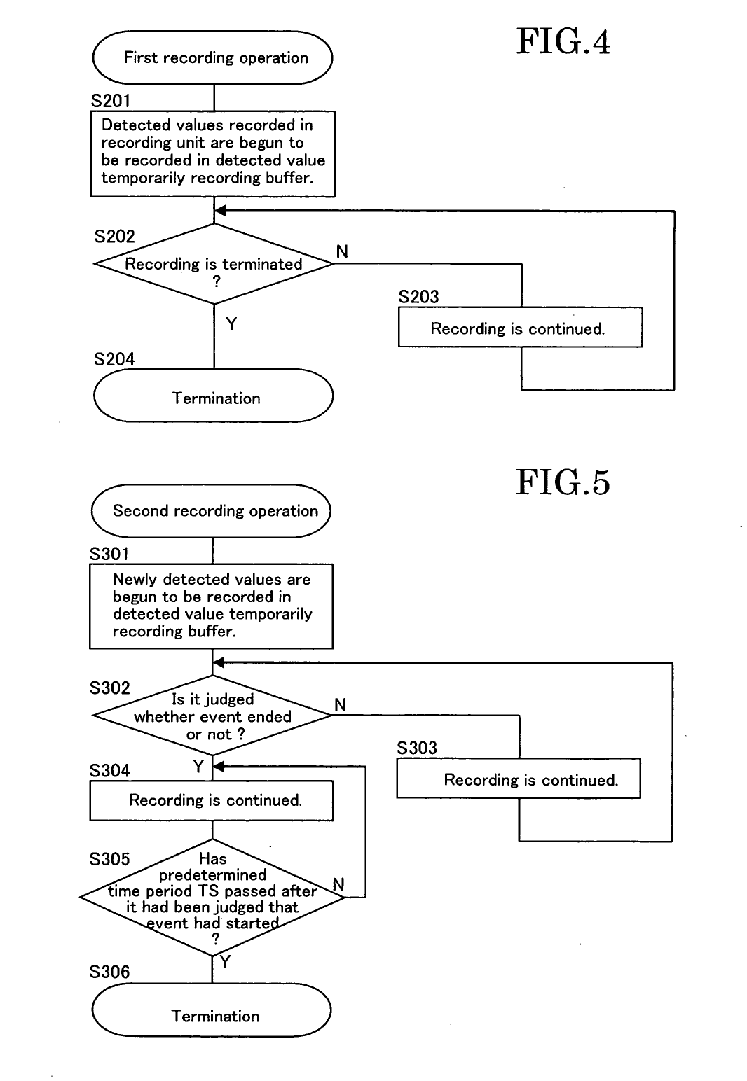

The above-mentioned first recording operation will be explained by using the flow chart in FIG. 4.

In Step S201, recording operation is performed: the detected values of the front acceleration sensor 211, the central acceleration sensor 212, the right side acceleration sensor 213, the left side acceleration sensor 214, the angular velocity sensor 215, the vehicle velocity sensor 221, the engine-rpm sensor 222, the brake on/off sensor 223 and the accelerator open degree sensor 224 already recorded in the first ring buffer 121 to the ninth ring buffer 129 of the recording unit 120 are begun to be recorded into a first recording area of the detected value temporarily storing buffer 131 of the recording/storing unit 130 at the point of time when it is judged that the event starts. Thereafter, the flow moves to Step S202.

In Step 202, it is judged whether the recording is terminated in Step S201 or not. If it is judged that the recording is terminated, the flow moves to Step S204. On the other hand, if it is judged that the recording is not terminated, the flow moves to S203.

In Step S203, recording is continued. Thereafter, the flow is returned to Step S202.

In Step S204, the first recording operation is terminated.

Next, the above-mentioned second recording operation will be explained by using a flow chart in FIG. 5.

In Step S301, recording operation is performed: newly detected values of the front acceleration sensor 211, the central acceleration sensor 212, the right side acceleration sensor 213, the left side acceleration sensor 214, the angular velocity sensor 215, the vehicle velocity sensor 221, the engine-rpm sensor 222, the brake on/off sensor 223 and the accelerator open degree sensor 224 already recorded in the first ring buffer 121 to the ninth ring buffer 129 of the recording unit 120 are begun to be recorded into a second recording area of the detected value temporarily storing buffer 131 of the recording/storing unit 130 at a point of time when it is judged that the event starts. The flow moves to Step S302.

In Step S302, the event-judging unit 111 decides whether it is judged that the event ended or not (mentioned later). If it is judged that the event ended (judgment of event ending), the flow moves to Step S304. On the other hand, if it is not judged that the event ended (no judgment of event ending), the flow moves to Step S303.

In Step S303, newly detected values of the front acceleration sensor 211, the central acceleration sensor 212, the right side acceleration sensor 213, the left side acceleration sensor 214, the angular velocity sensor 215, the vehicle velocity sensor 221, the engine-rpm sensor 222, the brake on/off sensor 223 and the accelerator open degree sensor 224 are continuously recorded into the second recording area of the detected value temporarily storing buffer 131. Thereafter, the flow moves to Step S302.

In Step S304, newly detected values of the front acceleration sensor 211, the central acceleration sensor 212, the right side acceleration sensor 213, the left side acceleration sensor 214, the vehicle velocity sensor 221, the engine-rpm sensor 222, the brake on/off sensor 223 and the accelerator open degree sensor 224 are continuously recorded into the second recording area of the detected value temporarily storing buffer 131 of the recording/storing unit 130 when the event-starting judgment is perform 302. The flow moves to Step S305

In Step 305, it is decided whether a given time period TE2 passed or not after it was judged that the event started. If the given time period TE2 passed after it was judged that the event started, the flow moves to Step S306. On the other hand, if it is decided that the given time period TE2 has not passed after it had been judged that the event had started, the flow returns to Step S304.

In Step S306, the second operation is terminated.

If it is judged that the even started, the detected values of the acceleration sensor unit 210 and the running state-detecting sensor unit 220 are recorded and stored in the detected value-storing unit 132 at the point of that time according to the above operations.

The newly detected values of the acceleration sensor unit 210 and the running state-detecting sensor unit 220 are recorded and stored in the detected value storing unit 132 during the time period from the point of time when it is judged that the event started to the lapse of time TE2 after the judgment of the event start.

If it is judged that the airbag is developed, the airbag body 150 is developed in addition to the above operations.

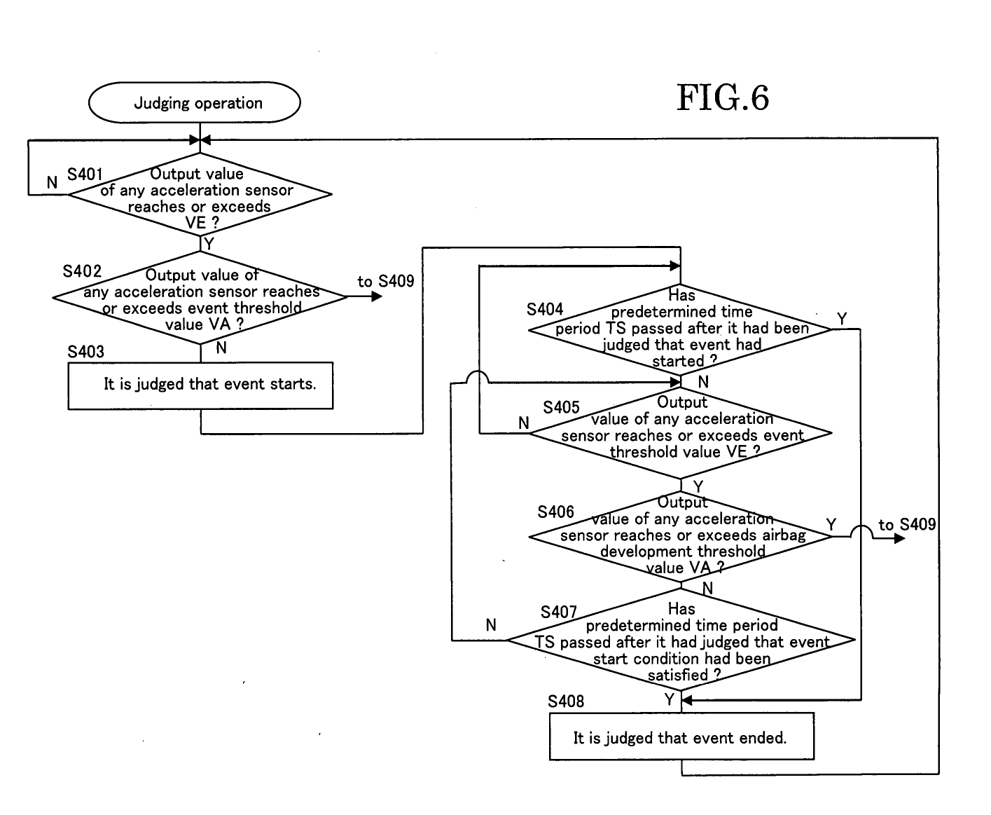

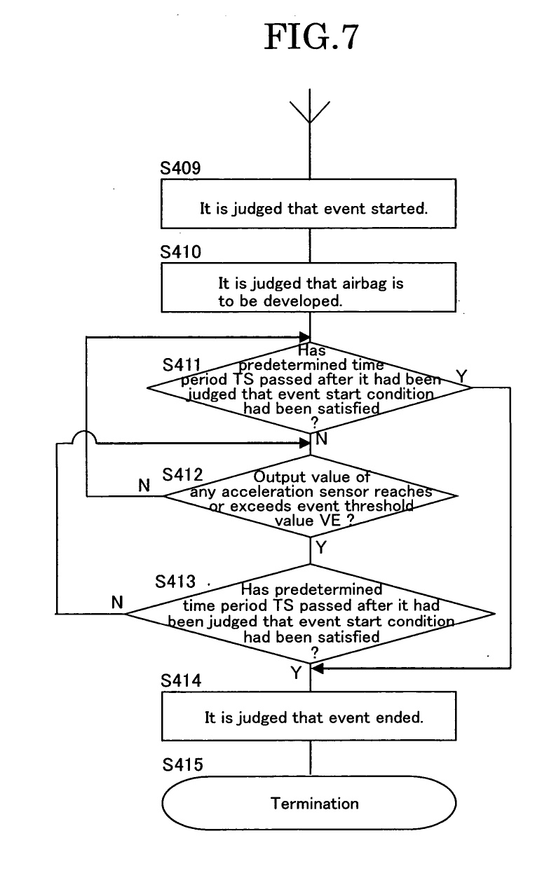

Next, the event start judging operation, the event end judging operation and the airbag development operation as mentioned above will be explained by using flow charts in FIGS. 6 and 7 and a timing chart in FIG. 8.

In Step S401, it is judged whether the event starts or not, by comparing the output values V1 to V5 of the front acceleration sensor 211, the central acceleration sensor 212, the right side acceleration sensor 213, the left side acceleration sensor 214 and the angular velocity sensor 215 with the event start threshold values VE1 to VE5. If any event start condition among V1≧VE1, V2≧VE2, V3≧VE3, V4≧VE4 and V5≧VE5 is not satisfied, the flow is returned to Step S401, and is placed in a waiting state. On the other hand, any of the event start conditions among V1≧VE1, V2≧VE2, V3≧VE3, V4≧VE4 and V5≧VE5 is satisfied, the flow moves to Step S402.

In Step 402, it is judged whether the event start condition satisfied in Step S401 meets the airbag developing condition or not. It is judged whether the airbag is to be developed or not, by comparing the output values V1 to V5 of the front acceleration sensor 211, the central acceleration sensor 212, the right side acceleration sensor 213, the left side acceleration sensor 214 and the angular velocity sensor 215 with the airbag developing threshold values VA1 to VA5, respectively. If any airbag development condition among V1≧VA1, V2≧VA2, V3≧VA3, V4≧VA4 and V5≧VA5 is not satisfied, the flow is returned to Step S403. On the other hand, any of the airbag development conditions among V1≧VA1, V2≧VA2, V3≧VA3, V4≧VA4 and V5≧VA5 is satisfied, the flow moves to Step S409 in FIG. 7.

In Step S403, it is judged whether an event starts or not. Thereafter, the flow moves to Step S404.

In Step S405, it is judged whether a predetermined time period TS passed or not, without satisfaction of a new event start condition, after it was judged that the event started. If it is judged that the predetermined time period TS passed, without satisfaction of a new event start condition, after it was judged that the event started, the flow moves to Step S408. On the other hand, if it is judged that the predetermined time period TS has not pass after it was judged that the event started, the flow moves to Step 405.

In Step S405, it is judged whether a new event start condition is satisfied or not after it was judged that the event started, by comparing the output values V1 to V5 of the front acceleration sensor 211, the central acceleration sensor 212, the right side acceleration sensor 213, the left side acceleration sensor 214 and the angular velocity sensor 215 with the event start threshold values VE1 to VE5, respectively. If any event start condition among V1≧VE1, V2≧VE2, V3≧VE3, V4≧VE4 and V5≧VE5 is not satisfied, the flow is returned to Step S404. On the other hand, if any of the event start conditions among V1≧VE1, V2≧VE2, V3≧VE3, V4≧VE4 and V5≧VE5 is satisfied, the flow is moved to Step S406.

In Step 406, it is judged whether the event start condition satisfied in Step S405 meets the airbag development condition or not. It is judged whether the airbag is to be developed or not, by comparing the output values V1 to V5 of the front acceleration sensor 211, the central acceleration sensor 212, the right side acceleration sensor 213, the left side acceleration sensor 214 and the angular velocity sensor 215 with the airbag developing threshold values VA1 to VA5, respectively. If any airbag development condition among V1≧VA1, V2≧VA2, V3≧VA3, V4≧VA4 and V5≧VA5 is not satisfied, the flow is returned to Step S407. On the other hand, any of the airbag development conditions among V1≧VA1, V2≧VA2, V3≧VA3, V4≧VA4 and V5≧VA5 is satisfied, the flow moves to Step S409 in FIG. 7.

In Step S407, it is judged whether the predetermined time period TS has passed or not, without establishment of new event start condition, after it had been judged in Step S405 that the event had started. In Step S407, if it is judged that the predetermined time period TS has passed, without establishment of new event start condition, after it had been judged that the event had started, the flow moves to Step S408. On the other hand, in Step S407, it is judged that the predetermined time period TS has not passed after it had been judged that the event had started, the flow is returned to Step 405.

In Step 408, it is judged whether the event ended or not. Then, the flow is returned to Step S401.

Then, the flow chart in FIG. 7 will be explained.

In Step 409, it is judged similar to Step S403 whether an event started or not. Thereafter, the flow moves to a step S410.

In Step S410, it is judged that the airbag is to be developed.

In Step S411, it is judged whether the predetermined time period TS has passed or not, without establishment of a new event start condition, after it had been judged in Step S409 that the event had started. If it is judged that the predetermined time period TS has passed, without establishment of the new event start condition, after it had been judged in Step S409 that the event had started, the flow moves to Step S414. On the other hand, it is judged that the predetermined time period TS has not pass after it had been judged in Step S409 that the event had started, the flow moves to Step 412.

In Step S412, it is judged whether a new event start condition is satisfied or not after it has been judged that the event has started, by comparing the output values V1 to V5 of the front acceleration sensor 211, the central acceleration sensor 212, the right side acceleration sensor 213, the left side acceleration sensor 214 and the angular velocity sensor 215 with the event start threshold values VE1 to VE5, respectively. If any event start condition among V1≧VE1, V2≧VE2, V3≧VE3, V4≧VE4 and V5≧VE5 is not satisfied, the flow is returned to Step S411. On the other hand, any of the event start conditions among V1≧VE1, V2≧VE2, V3≧VE3, V4≧VE4 and V5≧VE5 is satisfied, the flow moves to Step S413.

In Step 413, it is judged whether the predetermined time period TS has passed or not, without satisfaction of a new event start condition, after it had been judged in Step S412 that the event start condition had been satisfied. In Step S412, if it is judged that the predetermined time period TS has passed, without satisfaction of the new event start condition, after it had been judged that the event start condition had been satisfied, the flow moves to Step S413. On the other hand, it is judged that the predetermined time period TS has not passed after it had been judged that the event start condition had been satisfied, the flow moves to Step 412.

In Step S414, it is judged that the event ended. Thereafter, the flow moves to Step S415.

In Step 415, the judgment operation is terminated.

In the above operations, the output values V1 to V5 of the front acceleration sensor 211, the central acceleration sensor 212, the right side acceleration sensor 213, the left side acceleration sensor 214 and the angular velocity sensor 215 are compared with the event occurrence threshold values VE1 to VE5, respectively. If any event start condition among V1≧VE1, V2≧VE2, V3≧VE3, V4≧VE4 and V5≧VE5 is satisfied, it is judged that the event started.

It is judged that the event ends in the predetermined time period TS after it was judged that the event started.

For example, if the output value V2 of the central acceleration sensor 212 reaches or exceeds the event start threshold value VE2 at the point of time t9, it is judged that the event started at the point of time t2 and it is judged at the point of time t10 after the lapse of the given time period TS counted from t2 that the event ended.

In this case, when any of the event start conditions of V1≧VE1, V2≧VE2, V3≧VE3, V4≧VE4 and V5≧VE5 is satisfied before the lapse of the predetermined time period TS after it is judged that the event started, it is not judged whether an event starts or not at a point of time when the event start condition is satisfied, but it is judged whether the event ended or not, in the predetermined time period TS from the point of time when the event start condition was satisfied.

For example, in FIG. 8, it is judged at the point of time t2 whether the event started or not when the output value V1 of the front acceleration sensor 211 reaches or exceeds the event start threshold value VE1 at the point of time t2. Even when the output value V2 of the central acceleration sensor 212 reaches or exceeds the event start threshold value VE2 at a point of time t3 before a point of time t4 lapsed by the predetermined time period TS from t2, it is not judged at the point of time t3 whether the event starts or not.

Similarly, it is not judged at a point of time t5 whether the event started or not, even when the output value V2 of the central acceleration sensor 212 reaches or exceeds the event start value VE2 at a point of time t3 and when the output value V3 of the right side acceleration sensor 213 reaches or exceeds the event start threshold value VE3.

If none of the event start conditions of V1≧VE1, V2≧VE2, V3≧VE3, V4≧VE4 and V5≧VE5 is satisfied until the lapse of the time period TS from the point of time t5, it is judged whether the event ended or not, at the point of time t7 which is later by the predetermined time period TS from the point of time t5.

If it is judged that any of the airbag development conditions of V1≧VA1, V2≧VA2, V3≧VA3, V4≧VA4 and V5≧VA5 is satisfied, by comparing the output values V1 to V5 of the front acceleration sensor 211, the central acceleration sensor 212, the right side acceleration sensor 213, the left side acceleration sensor 214 and the angular velocity sensor 215 with the airbag development threshold values VA1 to VA5, respectively, it is judged whether the airbag is to be developed or not.

If the event start condition is satisfied again after it is judged that the event ended, a first recording operation and a second recording operation are newly performed. By these operations, detected values of the accelerator sensor unit 210 and the running sate detection sensor unit 220 corresponding to the finally occurred event can be stored.

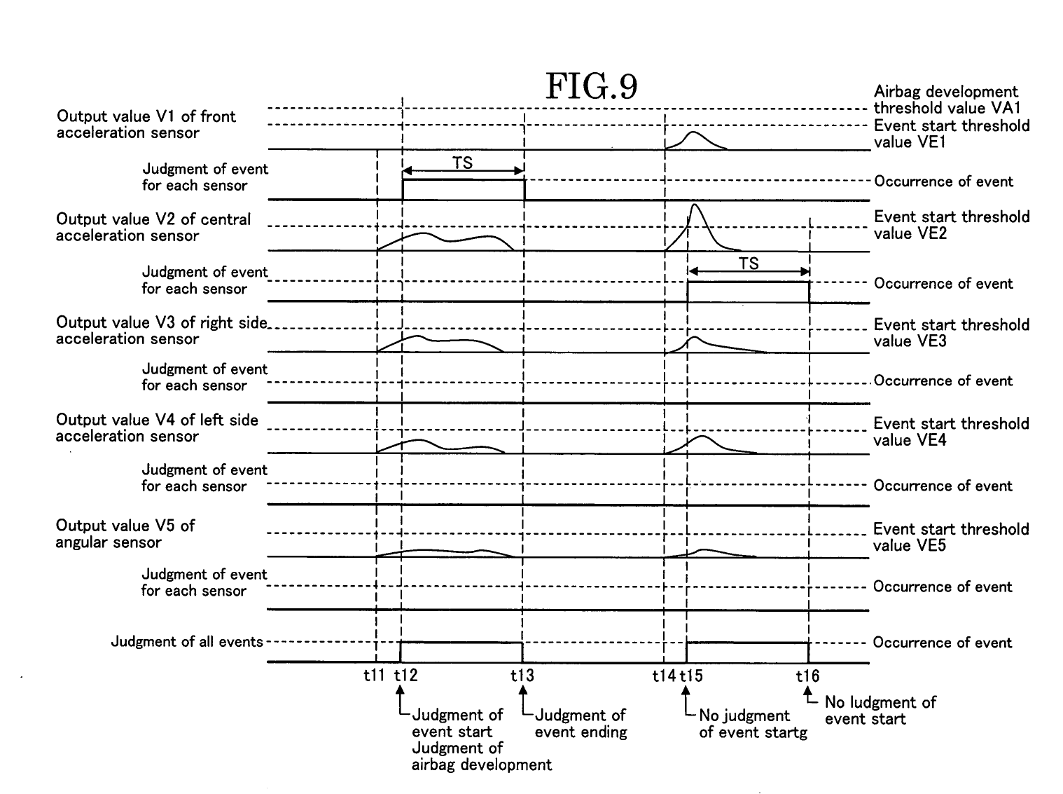

However, after it is judged that the airbag is to be developed, neither the first recording operation nor the second recording operation is performed even if the event start condition is satisfied again. For example, as shown in FIG. 9, if the airbag is developed when the output value V1 of the front acceleration sensor 211 reaches or exceeds the airbag start threshold value VA1 at the point of time t2 and when it is judged that the event started and that the airbag is to be developed, it is not judged at the point of time t15 whether the event starts or not, even if the output value V2 of the central acceleration sensor 212 reaches or exceeds the event start threshold value VE2, so that the first recording operation or the second recording operation is not performed. Through these operations, the detected values of the acceleration sensor unit 210 and the running state detection sensor unit 220 can be assuredly stored when the event to be accompanied with the development of the airbag occurs.

As mentioned above, the detected values of the acceleration sensor unit 210 and those of the running state detection sensor unit 220 are constantly recorded in the recording unit 120 at a predetermined sampling interval.

If the airbag development condition is satisfied in that the output value of the acceleration sensor unit 210 reaches or exceeds the airbag development threshold value, the airbag is developed and the detected values of the acceleration sensor unit 210 and the running state detecting sensor unit 220 recorded in the recording unit 120 at that time are recorded and stored in the detected value storing unit 132. By this operation, the airbag can be assuredly developed, and the detected values of the acceleration sensor unit 210 and those of the running state detection sensor unit 220 can be recorded and stored on developing the airbag.

Further, when the output value of the acceleration sensor unit 210 reaches or exceeds the event start threshold value and the event start condition is satisfied, the detected values of the acceleration sensor unit 120 and the running state detection sensor 220 recorded in the recording unit 120 at the point of that time are recorded and stored in the detected value storing unit 132. Through this operation, when the event occurs, for example, an impact force not smaller than a predetermined value is applied to the vehicle from the outside, the detected values of the acceleration sensor unit 210 and those of the running state detection sensors can be recorded and stored at that time.

After the detected values of the acceleration sensor unit 210 and the running state detection sensor unit 220 are recorded in the recording/storing unit 130, following the occurrence of the event, the detected values of the acceleration sensor unit 210 and the running state detection sensor 220 are newly recorded in the recording/storing unit 130. By this operation, the detected values of the acceleration sensor unit 210 and the running state detection sensor unit 220 corresponding to the finally occurred event can be recorded and stored.

After the airbag is developed, the detected values of the acceleration sensor unit 210 and the running state detection unit 220 recorded in the recording unit 120 are not recorded or stored in the recording/storing unit 130. By this operation, the detected values of the acceleration sensor and the running state detecting sensor at the time of developing the airbag can be assuredly stored.

In the above, the embodiments of the present invention have been explained in detail. However, this embodiment is merely an illustration of the present invention. The present invention is not limited to the construction of the embodiments alone. Therefore, it goes without saying that any changes, modifications and variations in design or the like of the same will be encompassed by the present invention so long as they do not depart from the gist or the spirit of the invention.

For example, the locations and the number of the sensors attached are not limited to those shown in the embodiment.

Further, the running state detection sensor is not limited to those described in connection with the embodiment, and may be those for detecting the running state of the vehicle.

The detected values of the running state detecting sensors can be taken in not via the CAN but directly.

The block diagrams are not limited to those described in the attached drawings, but constructions having the functions may be used.

What is claimed is:

1. A vehicle data recorder comprising:
a plurality of vehicle state-detecting sensors for detecting a state of a vehicle at the time of running;
a recording unit for temporarily recording detected values of said plurality of the vehicle state detecting sensors;
a recording/storing unit for recording and storing the detected values of said plurality of the vehicle state detecting sensors;
an airbag body installed inside an interior of the vehicle and configured to mitigate an impact force applied from an exterior of the vehicle;
an airbag body controller configured to inflate the airbag body upon receipt of a trigger signal from outside thereof;
a judging unit configured to judge that an event starts when a detected value of a given one of said plurality of the vehicle state-detecting sensors reaches or exceeds a first threshold value and to judge that the airbag body is to be developed when said given one vehicle state-detecting sensor reaches or exceeds a second threshold value, the first threshold value being lower than the second threshold value; and
a control unit configured for performing (i) an recording operation that the detected values of said vehicle state detection sensors are recorded and taken into the recording unit at a predetermined cycle, (ii) a recording/storing operation that when the judging unit judges that said event starts, the detected values of the vehicle state-detecting sensors recorded in the recording unit are recorded and stored in said recording/storing unit, and (iii) an airbag controlling operation that when the judging unit judges that the airbag is to be developed, the control unit outputs said trigger signal to said airbag body control unit.

2. The vehicle data recorder set forth in claim 1, wherein said given one vehicle state-detection sensor comprises a plurality of vehicle state-detecting sensors, first and second threshold values are set for each of said plurality of the vehicle state-detecting sensors; it is judged that the event starts, when an event start condition that a detected value of any of said plurality of the vehicle state-detecting sensors reaches or exceeds the first threshold value is satisfied; and it is judged that the airbag is to be developed, when an airbag development condition that the detected value of any of said plurality of the vehicle state-detecting sensors reaches or exceeds the second threshold value is satisfied.

3. The vehicle data recorder set forth in claim 1, wherein even if a new event start condition is satisfied within a predetermined time period after said event start condition was satisfied, it is not judged that the event starts.

4. The vehicle data recorder set forth in claim 2, wherein even if a new event start condition is satisfied within a predetermined time period after said event start condition was satisfied, it is not judged that the event starts.

5. The vehicle data recorder set forth in claim 1, wherein after it is judged that the airbag is to be developed, it is not judged that the event starts, even if the event start condition is satisfied.

6. The vehicle data recorder set forth in claim 2, wherein after it is judged that the airbag is to be developed, it is not judged that the event starts, even if the event start condition is satisfied.

7. The vehicle data recorder set forth in claim 1, wherein said vehicle state-detecting sensor comprises an acceleration sensor configured for detecting an impact force applied from an exterior of the vehicle and a running state-detecting sensor configured for detecting a running state of the vehicle, and said given vehicle state-detecting sensor is said acceleration sensor.

8. The vehicle data recorder set forth in claim 2, wherein said vehicle state-detecting sensor comprises an acceleration sensor configured for detecting an impact force applied from an exterior of the vehicle and a running state-detecting sensor configured for detecting a running state of the vehicle, and said given vehicle state-detecting sensor is said acceleration sensor.

9. The vehicle data recorder set forth in claim 7, wherein said acceleration sensor comprises at least one of a front acceleration sensor arranged near a front side of the vehicle for detecting an impact force from said front side, a central acceleration sensor arranged in a central portion of the vehicle for detecting an impact forces from the front side, a right side and a left side of the vehicle, a right-side acceleration sensor arranged near the right side of the vehicle for detecting an impact force from the right side of the vehicle, a left side acceleration sensor arranged near the left side of the vehicle for detecting an impact forces from the left side of the vehicle, and an angular velocity sensor arranged near the central portion of the vehicle for detecting overturn of the vehicle.

10. The vehicle data recorder set forth in claim 8, wherein said acceleration sensor comprises at least one of a front acceleration sensor arranged near a front side of the vehicle for detecting an impact force from said front side, a central acceleration sensor arranged in a central portion of the vehicle for detecting an impact forces from the front side, a right side and a left side of the vehicle, a right-side acceleration sensor arranged near the right side of the vehicle for detecting an impact force from the right side of the vehicle, a left side acceleration sensor 214 arranged near the left side of the vehicle for detecting an impact forces from the left side of the vehicle, and an angular velocity sensor arranged near the central portion of the vehicle for detecting overturn of the vehicle.

11. The vehicle data recorder set forth in claim 7, wherein said running state-detecting sensor comprises at least one of a vehicle velocity sensor for detecting the velocity of the vehicle, an engine-rpm sensor for detecting the revolutions per minute of the engine installed in the vehicle, a brake on/off sensor for detecting the state of on/off of a brake, and an accelerator open degree sensor for detecting an open degree of an accelerator.

12. The vehicle data recorder set forth in claim 8, wherein said running state-detecting sensor comprises at least one of a vehicle velocity sensor for detecting the velocity of the vehicle, an engine-rpm sensor for detecting the revolutions per minute of the engine installed in the vehicle, a brake on/off sensor for detecting the state of on/off of a brake, and an accelerator open degree sensor for detecting an open degree of an accelerator.

13. The vehicle data recorder set forth in claim 9, wherein said running state-detecting sensor comprises at least one of a vehicle velocity sensor for detecting the velocity of the vehicle, an engine-rpm sensor for detecting the revolutions per minute of the engine installed in the vehicle, a brake on/off sensor for detecting the state of on/off of a brake, and an accelerator open degree sensor for detecting an open degree of an accelerator.

14. The vehicle data recorder set forth in claim 10, wherein said running state-detecting sensor comprises at least one of a vehicle velocity sensor for detecting the velocity of the vehicle, an engine-rpm sensor for detecting the revolutions per minute of the engine installed in the vehicle, a brake on/off sensor for detecting the state of on/off of a brake, and an accelerator open degree sensor for detecting an open degree of an accelerator.

15. The vehicle data recorder set forth in claim 1, wherein said recording unit comprises a so-called first-in, first-out type ring buffer.

16. The vehicle data recorder set forth in claim 2, wherein said recording unit comprises a so-called first-in, first-out type ring buffer.
